(19) United States
(12) Patent Application Publication
(10) Pub. No.: US 2021/0171414 A1
(43) Pub. Date: Jun. 10, 2021

(54) FERTILIZER COMPOSITION

(71) Applicant: RHODIA OPERATIONS, Paris (FR)

(72) Inventors: Zixian CHEN, Singapore (SG); Xiaobing XI, Shanghai (CN)

(21) Appl. No.: 16/761,355

(22) PCT Filed: Nov. 5, 2018
(86) PCT No.: PCT/CN2018/113912

§ 371 Date: May 4, 2020

(30) Foreign Application Priority Data
Nov. 6, 2017 (CN) PCT/CN2017/109486

(51) Int. Cl. C05G 3/50; C05G 5/23; C05G 1/00; C05F 11/02; C05C 11/00

(52) U.S. Cl. CPC C05G 3/50; C05G 5/23; A01C 21/00; C05F 11/02; C05C 11/00; C05G 1/00

(57) ABSTRACT

Provided is a fertilizer composition comprising: (a) a mineral fertilizer ingredient; (b) a surfactant composition comprising an alkyl polyglucoside, and a second surfactant; and (c) water. The fertilizer composition has very good stability coupled with very good wetting and spreading capacities when diluted.

This application claims priority to PCT international patent application no. PCT/CN2017/109486 filed on Nov. 6, 2017, the whole content of this application being incorporated herein by reference for all purposes.

### TECHNICAL FIELD

The present invention relates to a fertilizer composition comprising a mineral fertilizer ingredient and a surfactant composition.

### BACKGROUND

Aqueous fertilizers are widely used for agricultural applications. For example, aqueous fertilizers can be used via folio application or soil irrigation, so as to enhance growth of plants. Aqueous fertilizers usually contain high level of salts which provide sources of nutrients, hence surface tension of the aqueous fertilizers may be high. Such high surface tension could cause difficulties in wetting hydrophobic surfaces, for example plant leaves and soils, which will in turn affect efficacy of the aqueous fertilizers. In order to enhance the efficacy of aqueous fertilizers, additives or adjuvants, for example, surfactants, can be incorporated into the aqueous fertilizer formulations.

Surfactants are often added to improve the wetting and spreading capacities of aqueous fertilizers. A surfactant can be added in situ to the fertilizer solution/formulation before application of the fertilizer. Generally speaking, the surfactant must have good compatibility with the mineral fertilizer ingredient contained in the aqueous fertilizer, otherwise phase separation will appear when the surfactant is added into the aqueous fertilizer which has high salt level.

Selection of surfactants suitable for mineral fertilizers/nutrients is not simple. Among others, it is difficult to select a versatile surfactant that could lead to good performance of the aqueous fertilizers which is independent of type of the target plants. Furthermore, the surfactant must be very efficient so as to allow effective reduction of surface tension of the aqueous fertilizer formulations with only small amount of the surfactant being required.

Thus, there is a need for a fertilizer composition which can provide good stability, coupled with excellent wetting and spreading capacities after the fertilizer composition is diluted.

### SUMMARY OF THE INVENTION

The object of the present invention can be achieved by a fertilizer composition comprising:
(a) a mineral fertilizer ingredient;
(b) a surfactant composition comprising an alkyl polyglucoside and a second surfactant; and
(c) water.

In one aspect of the present invention, there is provided a fertilizer composition comprising:
(a) a mineral fertilizer ingredient containing a macronutrient ingredient, a secondary macronutrient ingredient, a micronutrient ingredient, an amino acid ingredient, a humic acid ingredient, or a combination thereof;
(b) a surfactant composition comprising
   an alkyl polyglucoside, and
   a second surfactant selected from a quaternary ammonium compound, an a tertiary amine and a combination thereof; and
(c) water.

In another aspect of the present invention, there is provided a fertilizer composition comprising:
(a) a mineral fertilizer ingredient containing a macronutrient ingredient, a secondary macronutrient ingredient, a micronutrient ingredient, an amino acid ingredient and a humic acid ingredient, or a combination thereof;
(b) a surfactant composition comprising
   a C₈-C₂₂ alkyl polyglucoside, and
   a second surfactant selected from a quaternary ammonium compound, a tertiary amine, and a combination thereof; and
(c) water.

In the fertilizer composition according to the present invention, the surfactant composition could provide good compatibility with the mineral fertilizer ingredient even when the mineral fertilizer ingredient contains high level of inorganic salts. The fertilizer composition could also provide very good wetting and spreading capacities when used in soils or on plant leaves. Excellent wetting and spreading capacities can be indicated by low surface tension of the fertilizer composition.

In another aspect of the present invention, there is provided a method for enhancing the wetting/spreading capacities of a fertilizer composition, comprising a step of adding to the fertilizer composition a surfactant composition described herein.

In still another aspect of the present invention, there is provided a method for feeding/fertilizing plants comprising a step of spraying the fertilizer composition described herein onto the plants, notably onto foliage of the plants.

### DETAILED DESCRIPTION

The term “comprising” as used throughout the specification shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

The term “optionally substituted” as used throughout the specification denotes that the group may or may not be further substituted or fused (so as to form a polycyclic system), with one or more non-hydrogen substituent groups. The substituent groups may be one or more groups independently selected from the group consisting of ═O, cycloalkyl, hydroxy, hydroxyalkyl, alkoxy, alkoxyalkyl, amino, alkylamino and aminoalkyl.

The term “hydrocarbon group” as used throughout the specification refers to a substituent or radical containing hydrogen and carbon atoms. The hydrocarbon group may have any suitable structures including saturated or unsaturated, straight or branched chain.

The term “alkyl” as a group or part of a group as used throughout the specification refers to a straight or branched aliphatic hydrocarbon group, such as a C₁-C₁₄ alkyl, a C₁-C₁₀ alkyl or a C₁-C₆ alkyl unless otherwise noted. Examples of suitable straight and branched C₁-C₆ alkyl substituents include methyl, ethyl, n-propyl, 2-propyl, n-butyl, sec-butyl, t-butyl, hexyl, and the like. The group may be a terminal group or a bridging group.

The term “alkenyl” as a group or part of a group as used throughout the specification refers to a straight or branched aliphatic hydrocarbon group containing at least one carbon-carbon double bond, such as a C₂-C₁₄ alkenyl, a C₂-C₁₀ alkenyl or a C₂-C₆ alkenyl unless otherwise noted.

The term “aryl” as a group or part of a group as used throughout the specification denotes (i) an optionally substituted monocyclic, or fused polycyclic, aromatic carbocycle (ring structure having ring atoms that are all carbon) that may have from 5 to 12 atoms per ring. Examples of aryl groups include phenyl, naphthyl, and the like; (ii) an optionally substituted partially saturated bicyclic aromatic carbocyclic moiety in which a phenyl and a C₅₋₇ cycloalkyl or C₅₋₇ cycloalkenyl group are fused together to form a cyclic structure, such as tetrahydronaphthyl, indenyl or indanyl. The group may be a terminal group or a bridging group.

The term “arylalkyl” as used throughout the specification means an aryl-alkyl-group in which the aryl and alkyl moieties are as previously described. Preferred arylalkyl groups contain a C₁₋₅ alkyl moiety. Exemplary arylalkyl groups include benzyl, phenethyl and naphthelenemethyl. The group may be a terminal group or a bridging group.

The term “hydroxyalkyl” as used throughout the specification means an alkyl radical, which is substituted with a hydroxyl groups, such as hydroxymethyl, hydroxyethyl, hydroxypropyl, and hydroxydecyl.

According to the present invention, a fertilizer composition comprising a mineral fertilizer ingredient and a surfactant composition is provided.

Mineral Fertilizer Ingredient

In context of the present invention, the mineral fertilizer ingredient refers to a fertilizer useful for applications such as fertigation, foliage dressing, soilless culturing, seed soaking and root dipping and the like via dissolving or diluting with water. The mineral fertilizer ingredient may contain a macronutrient ingredient, a secondary macronutrient ingredient, a micronutrient ingredient, an amino acid ingredient, a humic acid ingredient, or a combination thereof.

According to every one of the invention embodiments, the fertilizer composition preferably contains a macronutrient ingredient (macronutrient element source) selected from nitrogen, phosphorus, potassium, and a mixture thereof.

The source of nitrogen as an essential element in the macronutrient ingredient can be so called nitrogenous (N) fertilizers, i.e. nitrogen based fertilizers which comprise nitrogen containing salts. Nitrogen-based fertilizers are well known in the art and include urea-derived nitrogen, ammonium-derived nitrogen and nitrate-derived nitrogen. The source of urea-derived nitrogen can be urea, urea phosphate and UAN (aqueous solution of urea and ammonium nitrate). The source of ammonium-derived nitrogen can be ammonium salt, such as for example, ammonium nitrate, ammonium sulfate, calcium ammonium sulfate, ammonium formate, ammonium carbonate, ammonium bicarbonate, ammonium phosphate, ammonium hydrogendiphosphate, ammonium hydrogen-monophosphate, ammonium sodium hydrogenphosphate, and their mixtures. The source of nitrate-derived nitrogen can be a nitrate salt, such as for example potassium nitrate, ammonium nitrate and magnesium nitrate. It will be appreciated by a skilled person that some salts can be also a source of another element, such as magnesium.

The source of phosphorus as an essential element can be phosphorus salts which are well known in the art, and include for example monoamoniumphosphate (MAP), diamoniumphosphate (DAP), monopotasiumphosphate (MKP), dipotasiumphosphate, or amoniumpolyphosphate.

The source of potassium as an essential element can be potassium salts or oxides or hydroxide which are well known in the art, and include for example potassium oxide, potassium hydroxide, potassium chloride, potassium sulfate, potassium carbonate, or potassium nitrate.

The macronutrient ingredient can be also multinutrients (complex) fertilizers, which are the most common and include of two or more nutrient (NPK) elements.

In some embodiments, the mineral fertilizer ingredient may include a secondary macronutrient ingredient (secondary element source) which is selected from calcium salts, magnesium salts and mixture thereof. Calcium may be supplied as superphosphate, calcium nitrate, or calcium chloride solutions. Magnesium may be supplied a magnesium nitrate, magnesium sulphate, or magnesium chloride.

In some embodiments, the mineral fertilizer ingredient may include a micronutrient ingredient, including iron (Fe), manganese (Mn), molybdenum (Mo), zinc (Zn), boron (B) and copper (Cu). These elements can be provided as chemical compounds, usually watersoluble salts like nitrate, sulphate, or chloride. The micronutrient ingredient can be advantageously present as a chelate complex, e.g. with EDTA (ethylenediaminetetraacetic acid), IDHA (iminodisuccinic acid), DTPA (diethylenetriaminepentaacetic acid), or HBED (N,N′-di(2-hydroxybenzyl)ethylenediamine-N,N′-diacetic acid) and its derivatives and salts. This relates especially to those microelements that are prone to convert to insoluble (bio-unavailable) compounds at moderate soil pH and phosphate concentrations, such as iron and zinc.

In some embodiments, the mineral fertilizer ingredient may include a free amino-acid ingredient.

In some embodiments, the mineral fertilizer ingredient may include a humic-acid ingredient.

According to every one of the invention embodiments, the mineral fertilizer ingredient preferably comprises compounds selected from K₂O, P₂O₅, sugar alcohol chelated calcium, sugar alcohol chelated zinc, sugar alcohol chelated magnesium, sugar alcohol chelated boron, sugar alcohol chelated manganese, sugar alcohol chelated molybdenum, nitrate nitrogen, and the combination thereof.

It will be appreciated by a skilled person that the mineral fertilizer ingredient may include, as a fertilizer ingredient, a macronutrient ingredient, a secondary macronutrient ingredient, a micronutrient ingredient, an amino acid ingredient, or a humic acid ingredient as the sole fertilizer active ingredient.

In some embodiments, the mineral fertilizer ingredient may include, as a fertilizer ingredient, a macronutrient ingredient with the addition of a secondary macronutrient ingredient.

In some embodiments, the mineral fertilizer ingredient may include both a macronutrient ingredient and a micronutrient ingredient.

In some embodiments, the mineral fertilizer ingredient may include a macronutrient ingredient, a secondary macronutrient ingredient and a micronutrient ingredient.

In some embodiments, the mineral fertilizer ingredient may include a macronutrient ingredient, a secondary macronutrient ingredient, a micronutrient ingredient, an amino acid ingredient, a humic acid ingredient, or any combinations thereof.

It is appreciated that the macronutrient ingredient and the secondary macronutrient ingredient may be provided in the same chemical compound.

It is also appreciated that the fertilizer ingredient to be incorporated in the fertilizer composition could be readily selected by a skilled person and the selection may depend on type of the target plants for which the fertilizer composition is used.

In context of the present invention, the weight concentration of an essential element may be on the basis of the weight of the essential element in question, or alternatively calculated on the basis of the compound including this element and incorporated in the composition of the invention. It is a routine skill to convert concentration based on the weight of an element to concentration based on the weight of the compound including this element and vice-versa. When referring to the weight concentration of the mineral fertilizer ingredient, it means the total weight concentration of all essential elements contained in the fertilizer composition.

In some embodiments, the mineral fertilizer ingredient is present in an amount of about 10 wt % to about 90 wt % based on the total weight of the fertilizer composition.

In some embodiments, the mineral fertilizer ingredient is present in an amount of about 20 wt % to about 80 wt % based on the total weight of the fertilizer composition.

In some embodiments, the mineral fertilizer ingredient is present in an amount of about 30 wt % to about 70 wt % based on the total weight of the fertilizer composition.

In some embodiments, the mineral fertilizer ingredient is present in an amount of about 35 wt % to about 60 wt % based on the total weight of the fertilizer composition.

Surfactant Composition

The surfactant composition that can be used according to the present invention includes an alkyl polyglucoside and a second surfactant. The second surfactant is different from the alkyl polyglucoside.

The second surfactant may be preferably selected from a quaternary ammonium compound, a tertiary amine and a mixture thereof.

The alkyl polyglucoside suitable for the present invention may comprise one or more compounds having the general formula (I):

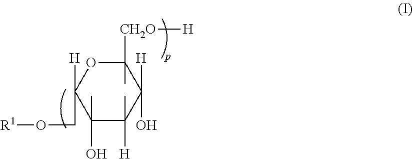

wherein:
R¹ is C₁-C₃₀ alkyl, hydroxyalkyl or aralkyl, more typically C₈-C₂₂ alkyl, and
p is an integer of from 1 to 10.

In some embodiments of the present invention, the alkyl polyglucoside further comprises one or more compounds of the general formula (II):

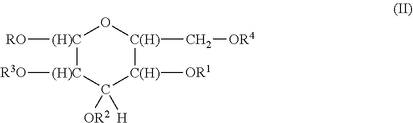

wherein:
R is an alkyl having 8 to 22 carbon atoms;
R¹, R², R³ and R⁴ are independently selected from the group consisting of —CH₂CH(OH)CH₂—R¹²
and H, with the proviso that at least one of R¹, R², R³ and R⁴ is —CH₂CH(OH)CH₂—R¹²;
R¹² is selected from the group consisting of —OH,

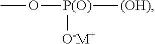

—SO₃⁻M⁺ and SO₄⁻2M⁺,
M is selected from the group consisting of Na, K, and NH₄.

In some embodiments of the present invention, the alkyl polyglucoside further comprises one or more compounds of the general formula (III):

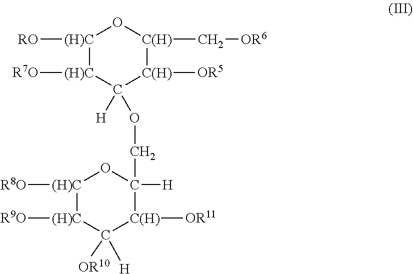

wherein:
R is an alkyl having 8 to 22 carbon atoms;
R⁵, R⁶, R⁷, R⁸, R⁹, R¹⁰, and R¹¹ are independently selected from group consisting of —CH₂CH(OH)CH₂—R¹²
and H, with the proviso that at least one of R⁵, R⁶, R⁷, R⁸, R⁹, R₁₀, and R¹¹ is —CH₂CH(OH)CH₂—R¹²;
R¹² is selected from the group consisting of —OH,

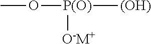

—SO₃⁻M⁺ and SO₄⁻2M⁺,
M is selected from the group consisting of Na, K, and NH₄;

The alkyl polyglucoside that can be used according to the present invention can be, for example, those described in U.S. Pat. No. 6,627,612 B1 and U.S. Pat. No. 8,633,136 B2.

Some preferred examples of the alkyl polyglucoside include, and are not limited to: octyl polyglucoside, decyl polyglucoside, dodecyl polyglucoside, tetradecyl polyglucoside, hexadecyl polyglucoside, and octadecyl polyglucoside.

According to the present invention, the surfactant composition comprises a second surfactant. The second surfactant may preferably be a quaternary ammonium compound, a tertiary amine and a mixture thereof.

The quaternary ammonium compound may be according to the general formula (V) or (VI):

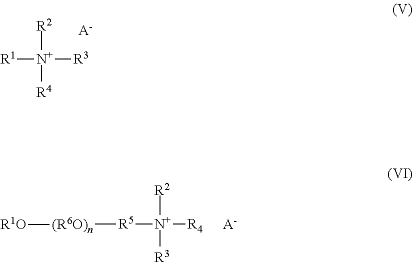

wherein:
R¹ is a straight or branched chain, saturated or unsaturated, optionally substituted, hydrocarbon group having from 4 to 30 carbon atoms, preferably an alkyl group of from 4 to 30 carbon atoms,
R² is hydrogen, methyl, ethyl, or —(CH₂CH₂O)ₓH,
R³ is hydrogen, methyl, ethyl, or —(CH₂CH₂O)_{y}H,
the sum of x and y is not more than about 5,
R⁴ is hydrogen or methyl,
R⁶ in each of the n (R⁶O) groups is independently C₂-C₄ alkylene,
R⁵ is hydrocarbylene or substituted hydrocarbylene having from 2 to about 6 carbon atoms, and A⁻ is an agriculturally acceptable anion.

The quaternary ammonium compound can be, for example, those described in U.S. Pat. No. 7,135,437 B2.

In some embodiments of the present invention, the quaternary ammonium compound is selected from dodecyl trimethyl ammonium chloride, hexadecyl trimethyl ammonium chloride, octadecyl trimethyl ammonium chloride, diotyl dimethyl ammonium chloride, dioctyl dimethyl ammonium chloride, didecyl dimethyl ammonium chloride, diotyl dimethyl ammonium chloride, dicocoalkyl dimethyl ammonium chloride, dodecyl dimethyl benzyl ammonium chloride, dodecyl/tetradecyl benzyl ammonium chloride, hydrogenated tallow benzyl ammonium chloride, di(hydrogenated tallow) benzyl ammonium chloride, and the combination thereof.

The tertiary amine may be according to the general formula (IX):

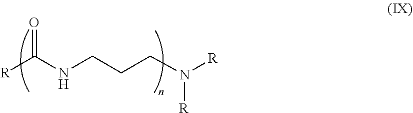

wherein:

R is a straight or branched chain, saturated or unsaturated, optionally substituted, hydrocarbon group having from 4 to 30 carbon atoms, preferably an alkyl group of from 4 to 30 carbon atoms;

n is an integer of 0 or 1, preferably n is 1.

The tertiary amine can be, for example, those described in U.S. Pat. No. 7,135,437 B2.

In some embodiments of the present invention, the tertiary amine is selected from N-3-cocoamidopropyl dimethylamine, N-3-laurylamidopropyl dimethylamine, N-3-oleylamidopropyl dimethylamine, N-3-erucylamidopropyl dimethylamine, octyl dimethyl amine, cocoalkyl dimethyl amine, decyl dimethyl amine, dodecyl dimethyl amine, tetradecyl dimethyl amine, hexadecyl dimethyl amine, octadecyl dimethyl amine, and the combination thereof.

In some embodiments of the present invention, the fertilizer composition comprises:
(a) a mineral fertilizer ingredient selected from a macronutrient ingredient, a secondary macronutrient ingredient, a micronutrient ingredient, an amino acid ingredient, a humic acid ingredient, and the combination thereof;
(b) a surfactant composition comprising
   an polyglucoside selected from octyl polyglucoside, decyl polyglucoside, dodecyl polyglucoside, tetradecyl polyglucoside, hexadecyl polyglucoside, octadecyl polyglucoside, and the combination thereof, and
   a second surfactant selected from dodecyl trimethyl ammonium chloride, hexadecyl trimethyl ammonium chloride, octadecyl trimethyl ammonium chloride, diotyl dimethyl ammonium chloride, dioctyl dimethyl ammonium chloride, didecyl dimethyl ammonium chloride, diotyl dimethyl ammonium chloride, dicocoalkyl dimethyl ammonium chloride, dodecyl dimethyl benzyl ammonium chloride, dodecyl/tetradecyl benzyl ammonium chloride, hydrogenated tallow benzyl ammonium chloride, di(hydrogenated tallow) benzyl ammonium chloride, and the combination thereof; and
(c) water.

In some embodiments of the present invention, the fertilizer composition comprises:
(a) a mineral fertilizer ingredient selected from a macronutrient ingredient, a secondary macronutrient ingredient, a micronutrient ingredient, an amino acid ingredient, a humic acid ingredient, and the combination thereof;
(b) a surfactant composition comprising
   an alkyl polyglucoside selected from octyl polyglucoside, decyl polyglucoside, dodecyl polyglucoside, tetradecyl polyglucoside, hexadecyl polyglucoside, octadecyl polyglucoside, and the combination thereof, and
   a second surfactant selected from N-3-cocoamidopropyl dimethylamine, N-3-laurylamidopropyl dimethylamine, N-3-oleylamidopropyl dimethylamine, N-3-erucylamidopropyl dimethylamine, octyl dimethyl amine, cocoalkyl dimethyl amine, decyl dimethyl amine, dodecyl dimethyl amine, tetradecyl dimethyl amine, hexadecyl dimethyl amine, octadecyl dimethyl amine, and the combination thereof; and
(c) water.

Preferably, the surfactant composition is present in the fertilizer composition in an amount of 0.1-5.0 wt % based on the total weight of the fertilizer composition.

In some embodiments of the present invention, the surfactant composition is present in an amount of 1.0-4.0 wt % based on the total weight of the fertilizer composition.

In some embodiments of the present invention, the surfactant composition is present in an amount of 1.5-3 wt % based on the total weight of the fertilizer composition.

In some embodiments of the present invention, the surfactant composition is present in an amount of about 2 wt % based on the total weight of the fertilizer composition.

In some embodiments of the present invention, the weight ratio of the alkyl polyglucoside to the second surfactant ranges from about 1:3 to about 3:1.

In some embodiments of the present invention, the weight ratio of the alkyl polyglucoside to the second surfactant ranges from about 1:1 to about 3:1.

In some embodiments of the present invention, the weight ratio of the alkyl polyglucoside to the second surfactant ranges from about 1:1 to about 1.3:0.7.

The fertilizer composition of the invention can be used for fertilizing/feeding plants directly. For example, the fertilizer composition can be used as a sprayable composition for spraying onto the plants, preferably onto foliage of the plants.

Preferably, the fertilizer composition of the invention is a concentrated composition, which is supplied to the final user as a concentrate and is diluted with water by the final user in a work tank, in accordance with recommendations of the manufacturer to obtain a working solution. Generally, concentrations of the concentrate in the working solution may be 1 to 6% v/v, such as 3% v/v.

The fertilizer composition may be supplied to the end user in a ready to use form. That is to say the fertilizer composition is provided to contain the mineral fertilizer ingredient as well as the surfactant composition described herein.

Alternatively, the surfactant composition described herein can be provided as a tank mix, which is to be added to and mixed with the mineral fertilizer ingredient by the end user just before its use in the spray treatment.

Other Ingredients

Except the mineral fertilizer ingredient and the surfactant composition, the fertilizer composition of the invention can include, when necessary, further utility adjuvant components known in the art, as long as they will have no adverse effects on the fertilizer composition. Additional ingredients that can be used in the fertilizer composition of the present invention include, but are not limited to, plant growth regulators, biostimulants, urease inhibitors, nitrification inhibitors, anti-foaming agents, wetting agents, dyes, drift control agents, thickening agents, deposition agents (stickers), water conditioners, compatibility agents, pH regulators, humectants, and UV absorbers, depending on the needs. These components are conventionally used in the art or are commercially obtainable.

It will be appreciated by a skilled person that water is present in the composition and its percentage will depend on the percentages of all other components in the composition so as to make up 100% in total.

Should the disclosure of any patents, patent applications, and publications which are incorporated herein by reference conflict with the description of the present application to the extent that it may render a term unclear, the present description shall take precedence.

### EXAMPLES

This application will be illustrated through the following examples, however, it should be understood that the present invention is not limited to the following examples.

Materials

“Oushen Ouhu” liquid fertilizer and “Oushen Weiguolu” liquid fertilizer purchased from Shanghai Hanhe Biotech. Co., Ltd.

“Oushen Ouhu” liquid fertilizer” has the following primary ingredients and corresponding contents:

| Active Ingredients | Content |
|---|---|
| Sugar Alcohol Chelated Calcium | 150 g/L |
| Sugar Alcohol Chelated Zinc | 45 g/L |
| Sugar Alcohol Chelated Magnesium | 10 g/L |
| Sugar Alcohol Chelated Boron | 3.5 g/L |
| Sugar Alcohol Chelated Manganese | 1.5 g/L |
| Sugar Alcohol Chelated Molybdenum | 1.0 g/L |
| Nitrate Nitrogen | 80 g/L |
| Organic Material | 150 g/L |
| Other Sugar Chelate | 100 g/L |

“Oushen Weiguolu” liquid fertilizer” has the following primary ingredients and corresponding contents:

| Active Ingredients | Content |
|---|---|
| K₂O | 450 g/L |
| P₂O₅ | 300 g/L |
| Zn | 2.0 g/L |
| B | 4.5 g/L |

In addition, the density and concentration of the fertilizers used in the examples are shown in the table below:

| | Density (g/cm³) | Active Concentration |
|---|---|---|
| Oushen Weiguolu | 1.63 | 46.38 wt % |
| Oushen Ouhu | 1.48 | 29.60 wt % |

APG0810: an alkyl polyglucoside available from Yangzhou Chenhua New Material Co., Ltd, having an active ingredient content of 50 wt %.

Fentacare® 1231-37: a quaternary ammonium salt, available from Solvay (Zhangjiagang) Specialty Chemicals Co., Ltd, having an active ingredient content of 37 wt %;

Tertiary Amine 1: a C₁₂-C₁₈ alkyl amidopropyldimethylamine, having an active ingredient content of 100 wt %;

Rhodasurf® 860/P: an alcohol ethoxylate, available from Solvay (Zhangjiagang) Specialty Chemicals Co., Ltd, having an active ingredient content of 100 wt %;

In addition, unless otherwise indicated, all the following examples are performed at ambient temperature and under atmospheric pressure, and all the stirring times of samples are 5 min.

The experimental instruments used are as follows:

Magnetic stirrer: Brand: IKA; Model: TOPOLINO S25.

### Example 1

To 98 g of liquid fertilizer (Oushen Weiguolu), 1.00 g of APG0810 and 1.00 g of Fentacare® 1231-37 were added with stirring at room temperature (25° C.). A transparent solution with no phase separation was obtained, which was observed with naked eyes at a room temperature immediately after the preparation.

### Example 2

To 98 g of liquid fertilizer (Oushen Weiguolu), 1.32 g of APG0810 and 0.68 g of Tertiary Amine 1 were added with stirring at room temperature. A transparent solution with no phase separation was obtained, which was observed with naked eyes at a room temperature immediately after the preparation.

### Example 3

To 98 g of liquid fertilizer (Oushen Ouhu), 1.32 g of APG0810 and 1.00 g of Tertiary Amine 1 were added with stirring at room temperature. A transparent solution with no phase separation was obtained, which was observed with naked eyes at a room temperature immediately after the preparation.

### Comparative Example 1

To 98 g of liquid fertilizer (Oushen Weiguolu), 2.00 g of Fentacare® 1231-37 was added with stirring at room temperature. Phase separation was observed in the obtained solution with naked eyes at a room temperature immediately after the preparation.

### Comparative Example 2

To 98 g of liquid fertilizer (Oushen Weiguolu), 2.00 g of Tertiary Amine 1 was added with stirring at room temperature. Phase separation was observed in the obtained solution with naked eyes at a room temperature immediately after the preparation.

### Comparative Example 3

To 98 g of liquid fertilizer (Oushen Weiguolu), 2.00 g of APG0810 was added with stirring at room temperature. A transparent solution with no phase separation was obtained, which was observed with naked eyes at a room temperature immediately after the preparation.

### Comparative Example 4

To 98 g of liquid fertilizer (Oushen Weiguolu), 2.00 g of Rhodasurf® 860/P was added with stirring at room temperature. Phase separation was observed in the obtained solution with naked eyes at a room temperature immediately after the preparation.

### Comparative Example 5

To 98 g of liquid fertilizer (Oushen Ouhu), 2.00 g of Fentacare® 1231-37 was added with stirring at room temperature. A transparent solution with no phase separation was obtained, which was observed with naked eyes at a room temperature immediately after the preparation.

### Comparative Example 6

To 98 g of liquid fertilizer (Oushen Ouhu), 2.00 g of Tertiary Amine 1 was added with stirring at room temperature. Phase separation was observed in the obtained solution with naked eyes at a room temperature immediately after the preparation.

### Comparative Example 7

To 98 g of liquid fertilizer (Oushen Ouhu), 2.00 g of APG0810 was added with stirring at room temperature. A transparent solution with no phase separation was obtained, which was observed with naked eyes at a room temperature immediately after the preparation.

### Comparative Example 8

To 98 g of liquid fertilizer (Oushen Ouhu), 2.00 g of Rhodasurf® 860/P was added with stirring at room temperature. Phase separation was observed in the obtained solution with naked eyes at a room temperature immediately after the preparation.

The results of the above examples are summarized in Table 1 below.

TABLE 1

| | | | Oushen | Oushen | Total | |
|---|---|---|---|---|---|---|
| | Surfactant 1 | Surfactant 2 | Weiguolu | Ouhu | surf. | Stability at |
| Samples | (wt %) | (wt %) | (wt %) | (wt %) | (wt %) | 25° C. |
| Example 1 | APG0810 (1.00) | FENTACARE ® 1231-37 (1.00) | 98 | — | 2.00 | limpid |
| Example 2 | APG0810 (1.32) | Tertiary Amine 1 (0.68) | 98 | — | 2.00 | limpid |
| Example 3 | APG0810 (1.32) | Tertiary Amine 1 (0.68) | — | 98 | 2.00 | limpid |
| Comparative Example 1 | FENTACARE ® 1231-37 (2.00) | — | 98 | — | 2.00 | separation |
| Comparative Example 2 | Tertiary Amine 1 (2.00) | — | 98 | — | 2.00 | separation |
| Comparative Example 3 | APG0810 (2.00) | — | 98 | — | 2.00 | limpid |
| Comparative Example 4 | RHODASURF ® 860/P (2.00) | — | 98 | — | 2.00 | separation |
| Comparative Example 5 | FENTACARE ® 1231-37 (2.00) | — | — | 98 | 2.00 | limpid |
| Comparative Example 6 | Tertiary Amine 1 (2.00) | — | — | 98 | 2.00 | separation |
| Comparative Example 7 | APG0810 (2.00) | — | — | 98 | 2.00 | limpid |
| Comparative Example 8 | RHODASURF ® 860/P (2.00) | — | — | 98 | 2.00 | separation |

Stability Test

Those sample solutions which were homogenous and transparent immediately after the preparation, were subjected to the stability test set out as below.

The stability test was conducted by storing the fertilizer compositions in a thermostatic chamber of 0° C. or 54° C. for 14 days, taking out the fertilizer compositions from the thermostatic chamber, and observing the conditions of the fertilizer compositions with naked eyes. The fertilizer compositions without phase separation, sedimentation and crystallization were considered as stable.

The results are provided in Table 2. As can be seen from Table 2, the inventive fertilizer compositions (Examples 1 to 3) and the fertilizer compositions of Comparative Examples 3, 5 and 7 maintained limpid during the stability test.

TABLE 2

| Samples | stability at 0° C. | stability at 54° C. |
|---|---|---|
| Example 1 | limpid (transparent) | limpid |
| Example 2 | limpid | limpid |
| Example 3 | limpid | limpid |
| Comparative | limpid | limpid |
| Example 3 | | |
| Comparative | limpid | limpid |
| Example 5 | | |
| Comparative | limpid | limpid |
| Example 7 | | |

Surface Tension Measurement

The fertilizer compositions which passed the stability test were subjected to a surface tension measurement. The surface tension was measured by diluting the fertilizer compositions 100 times with deionized water, and then measuring the dilution with Sigma 702 surface tension meter from Biolin.

The results are provided in Table 3. As can be seen from Table 3, the inventive fertilizer compositions (Examples 1 to 3) exhibited a reduced surface tension compared to those of the fertilizer compositions of Comparative Examples 3, 5 and 7, as well as the fertilizer compositions without any surfactants.

The surface tension of the Oushen Weiguolu fertilizer (as Control 1) and the Oushen Ouhu fertilizer (as Control 2) were measured and shown in Table 3. As can be seen from Table 3, the inventive fertilizer compositions also have a markedly lower surface tension compared to Controls 1 and 2.

TABLE 3

| Samples | Surface Tension (100x dilution) |
|---|---|
| Example 1 | 31.03 |
| Example 2 | 26.86 |
| Example 3 | 29.14 |
| Comparative | 35.27 |
| Example 3 | |
| Comparative | 34.99 |
| Example 5 | |
| Comparative | 33.37 |
| Example 7 | |
| Control 1 | 38.36 |
| Control 2 | 43.03 |

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the invention and the following claims.

1-15: (canceled)

16. A fertilizer composition comprising:
(a) a mineral fertilizer ingredient;
(b) a surfactant composition comprising an alkyl polyglucoside and a second surfactant; and
(c) water.

17. The fertilizer composition of claim 16, wherein the mineral fertilizer ingredient is present in an amount of about 30 wt % to about 70 wt % of the total weight of the fertilizer composition.

18. The fertilizer composition of claim 16, wherein the fertilizer ingredient contains a macronutrient ingredient, a secondary macronutrient ingredient, a micronutrient ingredient, an amino acid ingredient, a humic acid ingredient, or a combination thereof.

19. The fertilizer composition of claim 16, wherein the alkyl polyglucoside comprises one or more compounds having the general formula (I): 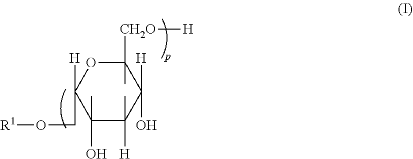
wherein:
R¹ is C₁-C₃₀ alkyl, hydroxyalkyl or aralkyl, and
p is an integer of from 1 to 10.

20. The fertilizer composition of claim 19, wherein the alkyl polyglucoside is selected from octyl polyglucoside, decyl polyglucoside, dodecyl polyglucoside, tetradecyl polyglucoside, hexadecyl polyglucoside, octadecyl polyglucoside, and the combination thereof.

21. The fertilizer composition of claim 16, wherein the second surfactant is selected from a quaternary ammonium compound, a tertiary amine, and a combination thereof.

22. The fertilizer composition of claim 21, wherein the quaternary ammonium compound is according to the general formula (V) or (VI): 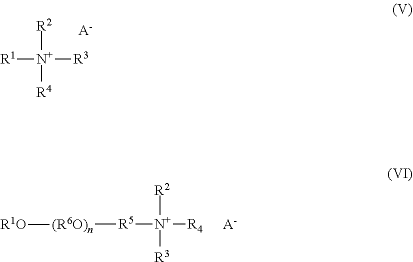
wherein:
R¹ is a straight or branched chain, saturated or unsaturated, optionally substituted, hydrocarbon group having from 4 to 30 carbon atoms,
R² is hydrogen, methyl, ethyl, or —(CH₂CH₂O)ₓH,
R³ is hydrogen, methyl, ethyl, or —(CH₂CH₂O)_{y}H,
the sum of x and y is not more than about 5,
R⁴ is hydrogen or methyl,
R⁶ in each of the n (R⁶O) groups is independently C₂-C₄alkylene,
R⁵ is hydrocarbylene or substituted hydrocarbylene having from 2 to about 6 carbon atoms, and
A⁻ is an agriculturally acceptable anion.

23. The fertilizer composition of claim 21, wherein the quaternary ammonium compound is selected from dodecyl trimethyl ammonium chloride, hexadecyl trimethyl ammonium chloride, octadecyl trimethyl ammonium chloride, diotyl dimethyl ammonium chloride, dioctyl dimethyl ammonium chloride, didecyl dimethyl ammonium chloride, diotyl dimethyl ammonium chloride, dicocoalkyl dimethyl ammonium chloride, dodecyl dimethyl benzyl ammonium chloride, dodecyl/tetradecyl benzyl ammonium chloride, hydrogenated tallow benzyl ammonium chloride, di(hydrogenated tallow) benzyl ammonium chloride, and the combination thereof.

24. The fertilizer composition of claim 21, wherein the tertiary amine is according to the general formula (IX): 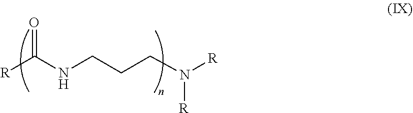
wherein R is a straight or branched chain, saturated or unsaturated, optionally substituted, hydrocarbon group having from 4 to 30 carbon atoms; and n is an integer of 0 or 1.

25. The fertilizer composition of claim 21, wherein the tertiary amine is selected from N-3-cocoamidopropyl dimethylamine, N-3-laurylamidopropyl dimethylamine, N-3-oleylamidopropyl dimethylamine, N-3-erucylamidopropyl dimethylamine, octyl dimethyl amine, cocoalkyl dimethyl amine, decyl dimethyl amine, dodecyl dimethyl amine, tetradecyl dimethyl amine, hexadecyl dimethyl amine, octadecyl dimethyl amine, and the combination thereof.

26. The fertilizer composition of claim 16, wherein the surfactant composition is present in an amount of 0.1-5.0 wt %, based on the total weight of the fertilizer composition.

27. The fertilizer composition of claim 16, wherein the weight ratio of the alkyl polyglucoside and the second surfactant is in the range of about 0.5:1.5 to about 1.5:0.5.

28. A method for enhancing the wetting/spreading capacities of a fertilizer composition which comprises a mineral fertilizer ingredient, the method comprising a step of adding to the fertilizer composition a surfactant composition; wherein the surfactant composition comprises an alkyl polyglucoside and a second surfactant.

29. The method according to claim 28, wherein the second surfactant is selected from a quaternary ammonium compound, a tertiary amine, and a combination thereof.

30. A method for feeding/fertilizing plants comprising a step of spraying the fertilizer composition according to claim 16 onto the plants.

31. The fertilizer composition of claim 19, wherein R¹ is a C₈-C₂₂ alkyl.

32. The fertilizer composition of claim 22, wherein R1 is an alkyl group of from 4 to 30 carbon atoms.
